(19) United States
(12) Patent Application Publication
(10) Pub. No.: US 2021/0068933 A1
(43) Pub. Date: Mar. 11, 2021

(54) DENTAL IMPLANT

(71) Applicant: BioClean Dental, LLC, Jupiter, FL (US)

(72) Inventors: William Edward Connell, Jupiter, FL (US); David Eleario Federici, Toms River, NJ (US)

(21) Appl. No.: 16/930,443

(22) Filed: Jul. 16, 2020

Related U.S. Application Data
(60) Provisional application No. 62/897,354, filed on Sep. 8, 2019.

(51) Int. Cl. A61C 13/07; A61C 8/00

(52) U.S. Cl. CPC A61C 13/0025; A61C 8/0068

(57) ABSTRACT

A multi-component dental implant system designed to improve oral hygiene. The dental implant system may comprise an implant body configured to be insertable into at least a portion of an individual's mouth, a primary or first abutment, a dental prosthesis engagement member, and a housing assembly. In use, the first abutment is designed to engage with and secure to the dental prosthesis engagement member. The housing is configured to secure to or cover the dental prosthesis engagement member. The dental implant system allows an individual to remove one or more components without the aid of any special tools or instruments.

### CROSS REFERENCE TO RELATED APPLICATIONS

In accordance with 37 C.F.R. 1.76, a claim of priority is included in an Application Data Sheet filed concurrently herewith. Accordingly, the present invention claims priority to U.S. Provisional Patent Application No. 62/897,354, entitled “Perfect Parallel Implant Component”, filed Sep. 8, 2019. The contents of the above referenced application are incorporated herein by reference in its entirety.

### FIELD OF THE INVENTION

The present invention relates to medical implants; to dental implants, devices and systems; and more particularly, to a multi-component dental implant system designed to be easily removed without the use of special removal tools, and methods of implanting dental implants.

### BACKGROUND OF THE INVENTION

Dental implants are well known in the dental field. For example, U.S. Pat. Nos. 10,588,721, 10,258,435, and U.S. Patent Application Publication No. 2015/0335401 are illustrative examples of dental implant systems. U.S. Pat. No. 10,588,721 is described as disclosing attachment systems for attaching removable dental prostheses to dental implants. U.S. Pat. No. 10,258,435 is described as disclosing an apparatus and method for adjustably retaining an oral appliance to an abutment assembly. In one variation, a securement apparatus is described to comprise a sleeve having a sleeve frame and a number of locking flaps. U.S. Patent Application Publication No. 2015/0335401 is described as providing a dental prosthesis attachment system for an endosseous dental implant. The dental prosthesis attachment system is described to include a removable dental prosthesis; a dental prosthesis portion secured to the removable dental prosthesis; and a dental implant portion securable to the dental implant and removably engageable with the dental prosthesis portion.

However, patients with many of these types of dental implants have difficulty maintaining proper oral hygiene. Many people who have implants with a dental hybrid are unable to properly clean around the implants on their own because the dental implant is screw retained. As a result of this construction, the cleaning process requires a dental professional to remove the hardware. Such process is time consuming for the dentist, and inconvenient for the patient. There is a need for an improved cleaning protocol of the implants and surrounding tissues for those individual patients wearing the dental hybrids or the dental practitioner whom they visit for cleaning and care appointments. The present invention addresses such need by providing a dental implant system in which one or more components implanted in the patient's mouth are easily accessible for proper cleaning and maintaining oral hygiene health.

### SUMMARY OF THE INVENTION

The present invention relates to a multi-component dental implant system designed to be easily removed without the use of special removal tools, and methods of implanting dental implants. The dental implant system is further designed to allow patients to better maintain oral hygiene, with the ability to remove one or more of the multiple components that make up the dental implant system. Easy removal of the one or more components of the multi-component dental implant system will also allow the patient to remove their dental prosthesis with their own hands and place in a denture cleaner or simply scrub with a tooth brush. Patients using the multi-component dental implant system will have full access to brush and floss around the implants in the mouth, thus enabling the patient to maintain the health of the surrounding tissues and prevent bone loss.

The multi-component dental implant system also provides dental implants and other components that are maintained in a parallel alignment. Providing an implant system designed to create parallelism with respect to neighboring or adjacent implant components within the same dental arch provides a system that requires less restorative space while possessing optimum retentive values to retain the removable prosthesis as compared to other systems. The multi-component dental implant system provides for corrective angling of the primary and/or the secondary structures with respect to adjacent and neighboring primary and/or the secondary structures in the same dental arch.

Accordingly, it is an objective of the invention to provide a multi-component dental implant system.

It is an objective of the invention to provide a multi-component dental implant system designed to improve oral hygiene.

It is an objective of the invention to provide a multi-component dental implant system in which one or more components are held together in an individual's mouth with friction rather than screws.

It is a further objective of the invention to provide a multi-component dental implant system designed to be easily removed without the use of special removal tools.

It is yet another objective of the instant invention to provide a multi-component dental implant system designed to maintain healthy oral hygiene.

It is a still further objective of the invention to provide a multi-component dental implant system designed to enable patients to maintain the health of the surrounding tissues and prevent bone loss.

It is a further objective of the invention to provide a multi-component dental implant system designed to enable patients to prevent bone loss caused by peri-implantitis/gingivitis, thus lack of hygiene.

It is yet another objective of the instant invention to provide a multi-component dental implant system designed to create parallelism with respect to neighboring or adjacent implant components within the same dental arch.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE FIGURES

FIG. 1A illustrates an embodiment of a multi-component dental implant system;

FIG. 1B illustrates the multi-component dental implant system shown in FIG. 1A, with the housing assembly removed;

FIG. 1C is a front elevation view, partly sectioned, of the multi-component dental implant system shown in FIG. 1A;

FIG. 1D is a sectioned, assembly view of the multi-component dental implant system.

FIG. 2 is an illustrative embodiment of the multi-component implant system, shown partially sectioned and without the implant body;

FIG. 3 is a front elevation view, partially sectioned, assembly view of the multi-component dental implant system, shown without the dental implant portion and a dental prosthesis portion;

FIG. 4 is an alternative exploded view of the multi-component implant system shown without the dental implant portion and a dental prosthesis portion;

FIG. 5 illustrates components of the multi-component implant system secured together;

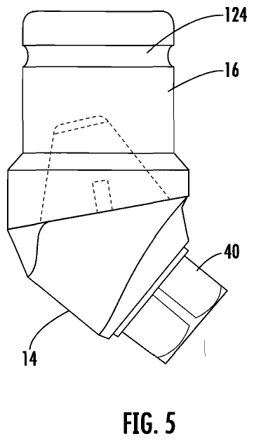

FIG. 6 is a perspective view of an illustrative embodiment of a dental implant;

FIG. 7 is a perspective view of a dental arch shown with multiple (four) dental implant sites with the dental implants surgically implanted therein;

FIG. 8 is a perspective view of the primary or first abutment;

FIG. 9 is a perspective view of the jaw model shown in FIG. 7, illustrating the non-parallel arrangement of one or more of the primary abutments;

FIG. 10 is a sectional view of the primary/first abutment, shown with an implant body screw pathway;

FIG. 11 is a sectional view, illustrating the securement of the primary abutment to the implant body;

FIG. 12 shows the dental prosthesis engagement member;

FIG. 13A is a perspective view of the dental prosthesis engagement member, illustrating the unique aspects of the bottom end;

FIG. 13B is an alternative view of the dental prosthesis engagement member, illustrating the varying positioning of an opening and screw channel based on the varying angles associated with the dental prosthesis engagement member collar;

FIG. 14 illustrates multiple implant bodies with dental prosthesis engagement members secured thereto, shown inserted into a bone ridge of a jaw mandible or maxilla of a jaw model;

FIG. 15 is a perspective view of an illustrative example of a dental prosthesis;

FIG. 16 illustrates multiple implant bodies with a housing assembly secured thereto, shown inserted into a bone ridge of a jaw mandible or maxilla of a jaw model; and

FIG. 17 is a schematic diagram illustrating an embodiment of an dental implant system method of use.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

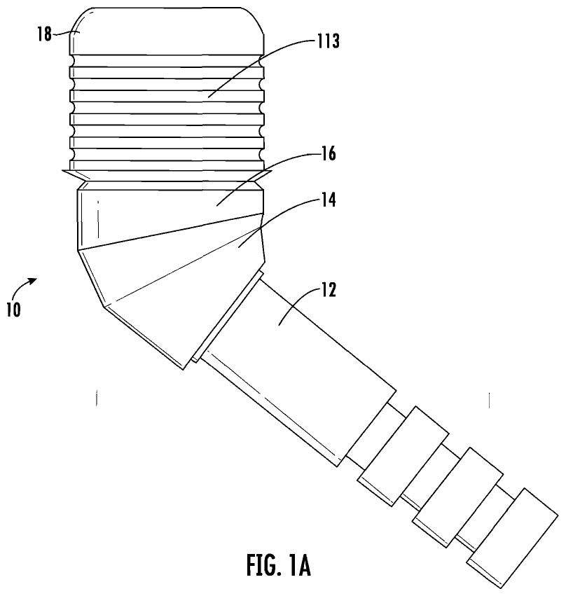

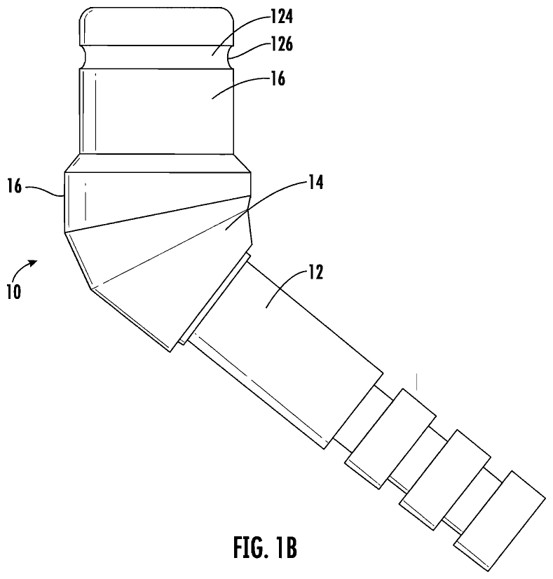

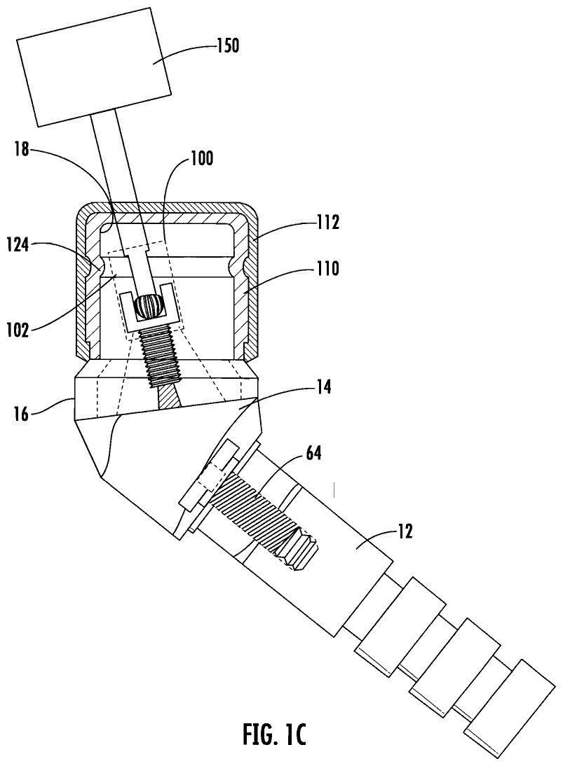

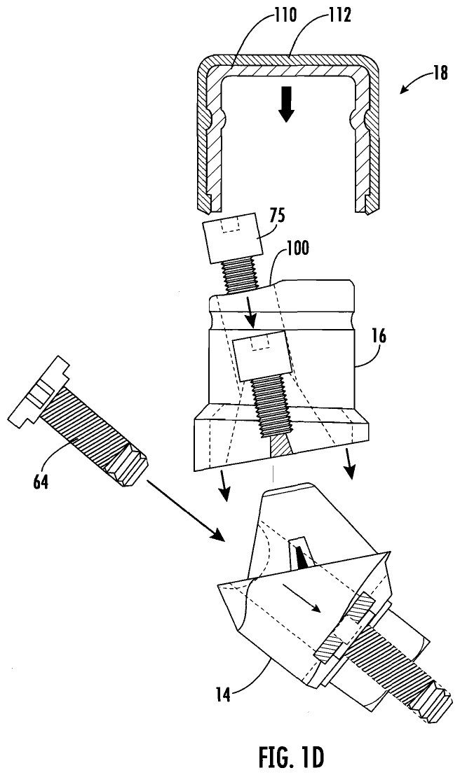

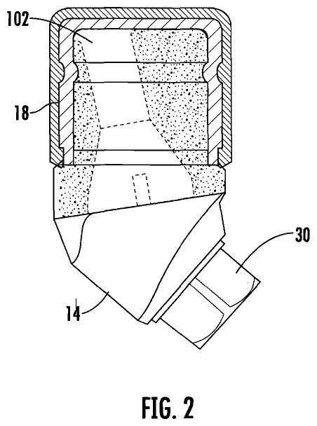

Referring to FIGS. 1A-1D, an illustrative embodiment of a multi-component implant system, referred to generally as dental implant system 10, is shown. While illustrated as an entire system, the dental implant system 10 includes one or more of the individual components, individually or in any combination. The dental implant system 10 may comprise an implant body 12 configured to be insertable into at least a portion of an individual's mouth, a primary or first abutment 14 (may also be referred to as a primary structure), a dental prosthesis engagement member 16 (may also be referred to as a secondary structure), and a housing assembly 18 (may also be referred to as a tertiary structure). In use, the primary or first abutment 14 is designed to engage with and secure to the dental prosthesis engagement member 16, see FIG. 2. The housing 18 is configured to secure to or cover the dental prosthesis engagement member 16. The dental implant system 10 allows easy removal of one or more components, such as the attachment of the first abutment 14 to the dental implant 12 or a dental prosthesis, without the aid of any special tools or instruments. Any of the individual components of the dental implant system may be prefabricated or custom made to individual patient needs.

The dental implant system 10 is configured to provide proper alignment when multiple dental implant systems 10 are inserted into a patient's mouth. In addition, the dental implant system 10 is configured to allow at least one component, such as the dental prosthesis engagement member 16 and a prosthesis, to be removable, preferably by the patient without the use of specialty implant tools, allowing the patient to remove and clean other components of the dental implant system 10, such as the implant body and abutments. Such configuration allows a patient to easily clean one or more of the individual components of the dental implant system 10, with full access to all sides of the implants that are implanted in the tissue.

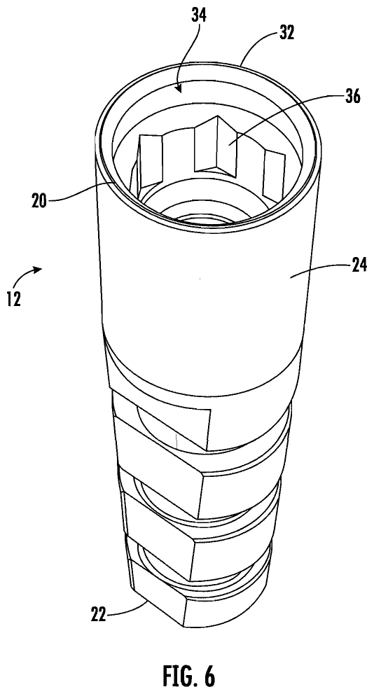

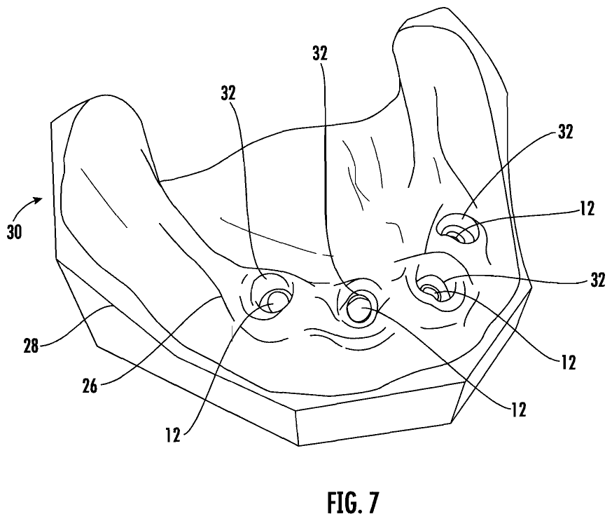

Referring to FIG. 6, an illustrative embodiment of the implant body 12 is illustrated. The implant body 12 comprises a first end 20, an opposing second end 22, and an elongated body 24 separating the first end 20 and the second end 22. The implant body 12 may be a conventional implant, such as an endosseous dental implant, and is configured to be surgically implanted into the bone ridge 26 of jaw mandible or maxilla 28, see FIG. 7. As illustrated, the dental arch 30 is shown with multiple (four) dental implant sites 32 having individual implant bodies 12 surgically implanted therein. The second end 22, which is inserted into the dental implant sites 32 first is preferably a closed end. The first end 20 comprises an opening 32, exposing an interior 34. The interior 34 may contain, at or near the first end 20, a first abutment member receiving member, illustrated as an internal (or external) hexagonal shape 36 configured to receive and secure to, with precision fit, at least a portion of the first abutment 14. While shown having a particular shape and size, such depiction is illustrative only. The implant body 12 can assume other shapes and/or sizes.

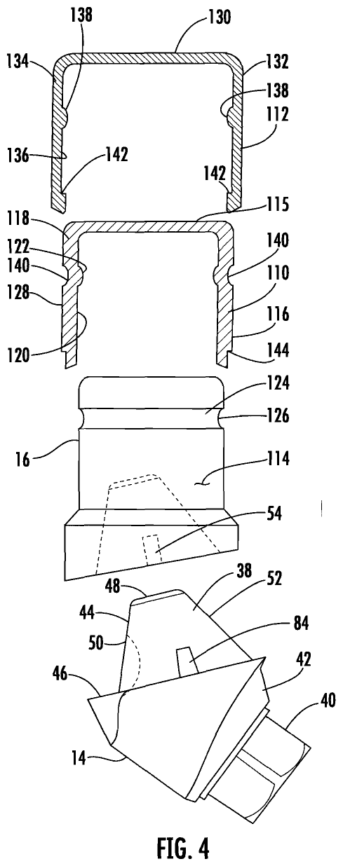

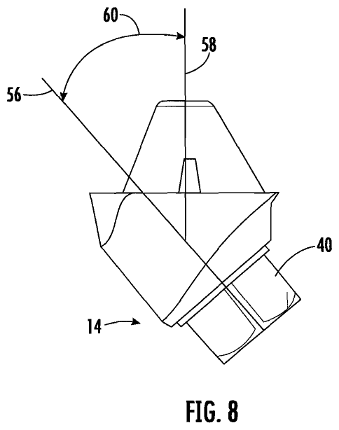

Referring to FIG. 4, the primary or first abutment 14 may comprise a first end 38 configured to receive and secure to at least a portion of the dental prosthesis engagement member 16, a second end 40 configured to receive and secure to at least a portion of the dental implant 12, and a main body 42 therebetween. The first end 38 may contain a first end body 44 extending upwardly, away from an upper surface 46 of the main body 42. The first end body 44 may have an upper surface 48, with two angled or diverging surfaces 50 and 52, thus forming a frustoconical or partial pyramid formation. The first end body 44 preferably comprises a first member of a first abutment to dental prosthesis engagement member locking system, illustrated herein as a female, clocking slot 54. The second end 40 may assume a hexagonal shape so as to fit with and secure to the first abutment member receiving member internal hexagonal shape 36 of the implant body 12. The second end 40 may be oriented so that its center plane or longitudinal axis 56 intersects a first end body center plane or longitudinal axis 58 at an angle, see FIG. 8. The primary or first abutment main body 42 may be modified so that the angle 60 formed by the intersection of the second end center plane or longitudinal axis 56 and the first end body center plane or longitudinal axis 58 is between greater than zero degrees and less than 45 degrees, between zero degrees and thirty degrees, preferably between two degrees and thirty degrees, and even more preferably zero degrees, six degrees, ten degrees, fourteen degrees, seventeen degrees, twenty-two degrees, twenty-six degrees, or thirty degrees. Using primary first abutments 14 having different angles 60 provides a mechanism to where the primary first abutments 14, when inserted into the patient jaw, align in a parallel manner or near parallel manner relative to adjacent units. The dental implant system 10 may therefore utilize one or more primary first abutments 14 having the same varying angles 60, one or more primary first abutments 14 having different angles 60, or combinations thereof.

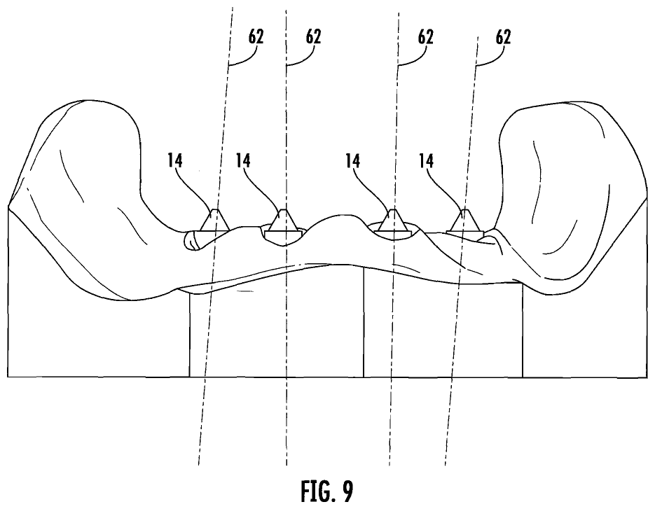

By choosing the correct primary first abutment angles 60 for each dental implant 12 inserted within the jaw, a dental practitioner can approximate parallel or near parallel arrangement. Referring to FIG. 9, vertical lines 62 illustrate positioning of multiple primary first abutments 14 placed to assume a position which is close to parallel relative to each other. As shown, there are still some discrepancies in which some of the multiple primary first abutments 14 are not in a parallel orientation or arrangement. The vertical lines 62 to the far left, for example, represent how the parallelism is slightly off from one of the primary/first abutments 14. Change of the angle 60 provides a mechanism to correct the slightly off parallel arrangement.

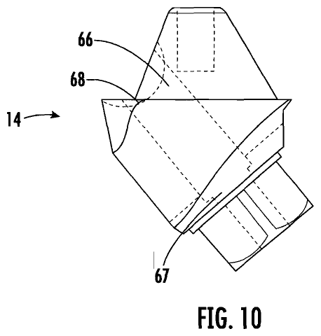

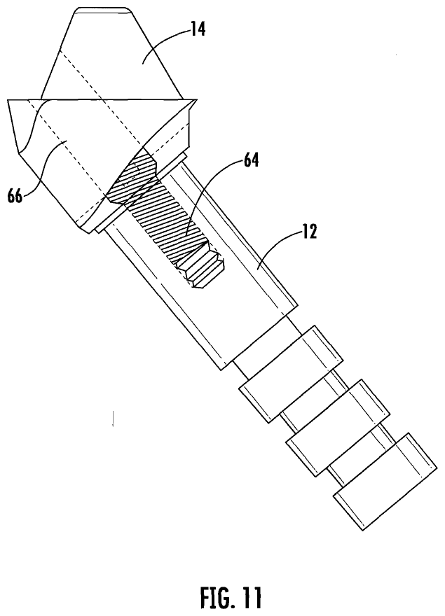

To secure the primary/first abutment 14 to the implant body 12, a threaded screw 64 (see FIG. 10 or 11) may be inserted into a screw channel 66, resting in a screw seat 67. The screw channel 66 is in an offset or off-center position, with an off-center opening 68. This orientation allows a user to insert the threaded screw 64 at an angle through the first end body 44.

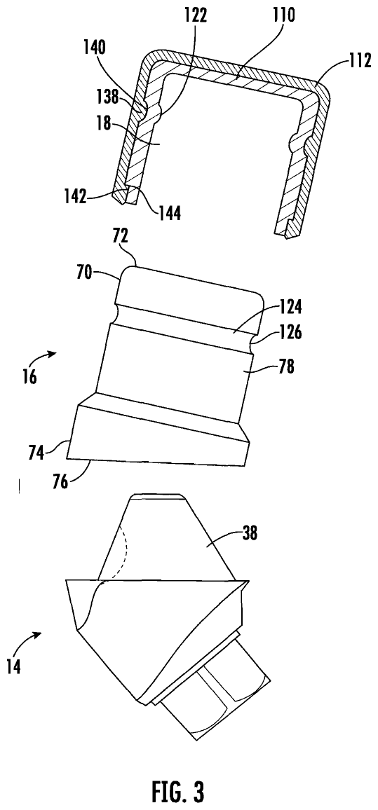

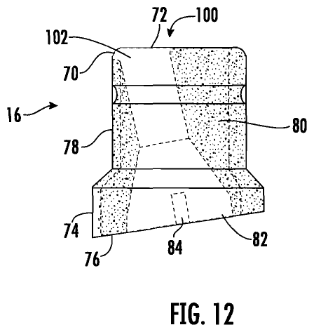

Referring back to FIG. 3, the dental prosthesis engagement member 16 is shown having an upper end 70 having a top surface 72, a bottom end or collar 74 having a bottom edge 76, and a dental prosthesis engagement member main body 78 therebetween. The dental prosthesis engagement member interior 80, see FIG. 12, is configured to engage with at least a portion of the primary/first abutment 14. A primary/first abutment receiving section 82 is a cut out portion within the interior 80, and has a complimentary shape to that of the first abutment first end body 44. When the first abutment first end body 44 is inserted therein, it fits within the primary/first abutment receiving section 82, allowing the bottom edge 76 of the the dental prosthesis engagement member 16 to rest on or butt against the upper surface 46 of primary/first abutment 14. To maintain the two components in place, the dental prosthesis engagement member interior 80 may comprise, a second member of the first abutment to dental prosthesis engagement member locking system, illustrated herein as a male clocking slot 84. The male clocking slot 84 provides a mechanism to correctly align the dental prosthesis engagement member 16 with the primary abutment 14, and also place the dental prosthesis engagement member 16 in a parallel orientation relative to other dental prosthesis engagement members 16 inserted within the jaw.

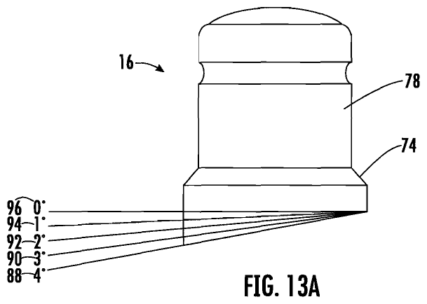

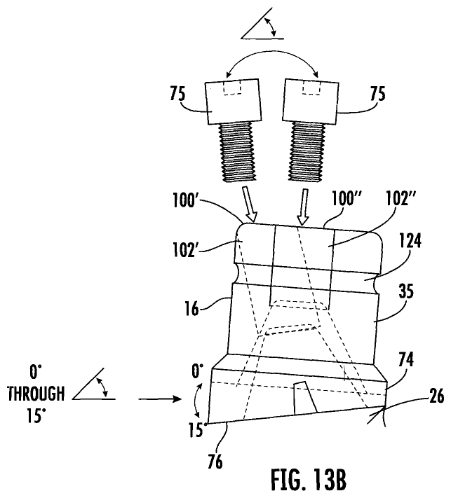

The bottom edge 76 of the dental prosthesis engagement member 16 in FIG. 12 is illustrated as an angled surface. As such, the dental prosthesis engagement member 16 may be configured to have a four-degree angle, see line 88 on FIG. 13A, a three-degree angle, see line 90, a two-degree angle, see line 92, a one-degree angle, see line 94, or a zero-degree angle, see line 96. While the dental prosthesis engagement member 16 is shown with the bottom edge 76 have an angled surface of zero to four degrees, it is preferred that the angle any be any value between zero and fifteen degrees, see FIG. 13B. The dental prosthesis engagement member 16 maybe custom made and configured to have a specific angle to correspond with other components, such as fit with the shape or angles associated with the primary abutment 14. In a dental arch with 4 dental implants, a patient may need varying degrees of correction to align in a prefect paralleled orientation. As such, dental implant system 10 may be configured so that dental prosthesis engagement member 16 may be designed to have an angle correction of 2.45 degrees for one implant body 12, a second dental prosthesis engagement member 16 may be designed to have an angle correction of 9.7 degrees for a second implant body 12, a third dental prosthesis engagement member 16 may be designed to have an angle correction of 11.2 degrees for a third implant body 12, and a fourth dental prosthesis engagement member 16 may be designed to have an angle correction of 5.5 degrees for a fourth implant body 12. The actual shape or angle of dental prosthesis engagement member 16 may be computer added design (CAD) and computer aided milling (CAM), or other means, such as sinter laser melting (SLM) or possible 3D printing technologies. Accordingly, the dental implant system 10 may therefore utilize one or more primary dental prosthesis engagement members 16 having the same degree angled surfaces (i.e. all with one-degree angles), one or more primary first abutments 14 having different degree angled surfaces (i.e. one with a four-degree angle, one with a two-degree angle, one with a one-degree angle, and one with a zero-degree angle), or combinations thereof. As a result, a dental practitioner using the dental implant system 10 provides implants in which each of the individual implants are arranged in a more parallel orientation relative to each other. The advantage of the dental implant system 10 provides components, when placed in the user's mouth, are parallel in orientation and in relation to each other.

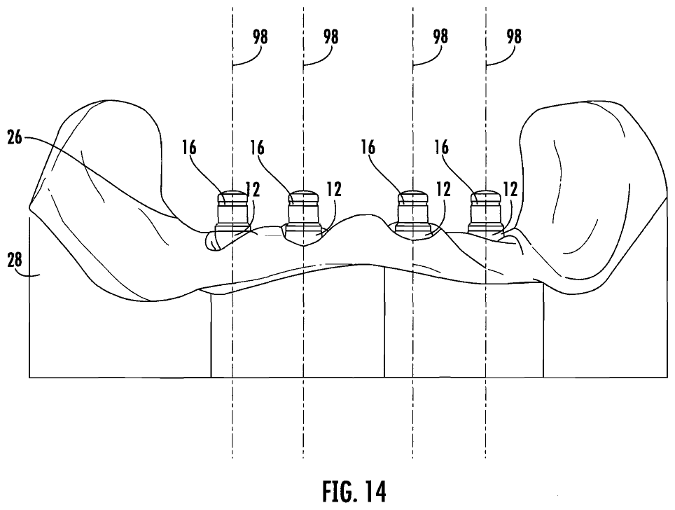

Referring to FIG. 14, multiple implant bodies 12 with dental prosthesis engagement member 16 secured thereto are shown inserted into the bone ridge 26 of the jaw mandible or maxilla 28. In this alignment, the implant bodies 12 with dental prosthesis engagement members 16 are aligned so each longitudinal axis 98 of each single implant body 12 with dental prosthesis engagement member 16 is in a parallel relationship relative to each of the next or adjacent implant bodies 12 with dental prosthesis engagement members 16.

The dental prosthesis engagement member upper end 70 may include an opening 100 with screw channel 102, see FIG. 12. The opening 100 and screw channel 102 may vary in location deepening on the required angled portions associated with dental prosthesis engagement member collar 74. FIG. 13B illustrates the opening 100 and screw channel 102 in the varying portions based on the varying angles between zero degrees and 15 degrees associated with the dental prosthesis engagement member collar 74. As an example, the opening 100 and screw channel 102 is illustrated with an off-center orientation 100′ and 102′ or center orientation 100″ and 102″. Teflon tape or a nylon plug may be used to plug the screw channel 102 after a threaded screw 75 has been inserted into place.

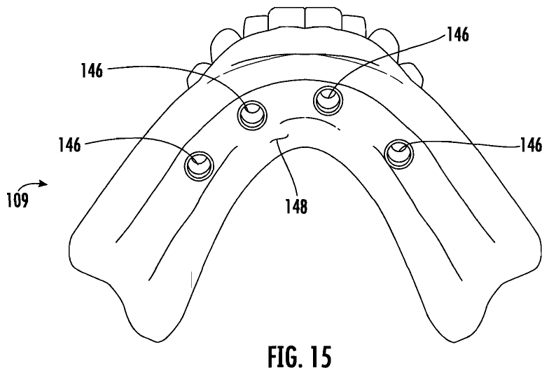

The dental implant system 10 is designed to allow one or more types of dental prosthesis, such as dentures 109, see FIG. 15, to secure to the implanted implants 12. Accordingly, the dental implant system 10 may include the housing assembly 18. The housing assembly 18 is configured to secure to the dental prosthesis engagement member 16 along one surface and to a dental prosthesis along a second, independent surface. Referring now to FIGS. 1C, 3, 4 and 16, the housing assembly 18 may comprise an inner member 110, preferably a flexible inner member 110, and an outer member 112, preferably a rigid outer member 112. The outer member 112 may include one or more mechanical retention members, such as ribbing 113, see FIG. 1A. The inner member 110, which may be referred to as a retention sleeve, preferably a flexible nylon retention sleeve or other retention type material (such as polyetheretherketone (PEEK) or polymer material), which is designed to fit onto and secure to the outer surface 114 of the dental prosthesis engagement member 16 and comprises a top portion or wall 115 and two side portions 116 and 118. The bottom portion is open. The nylon retention sleeve 110 may be made of different retention strengths. If part of a kit, the nylon retention sleeve 110 may be provided in different colors to indicate nylon retention sleeves 110 having different retention strengths.

The side portions or walls 116 and 118 may form a continuous side wall. The inner surface 120 is configured to align with and rest along the dental prosthesis engagement member outer surface 114 when the two components are secured together. The side portions or walls 116 and 118 and or the inner surface 120 may have a taper which is conjugate to a parallel or slightly tapering of the dental prosthesis engagement member 16 so that when the two components are slid on together, the inner surface 120 and the dental prosthesis engagement member outer surface 114 properly align.

To properly secure to the dental prosthesis engagement member 16, the inner surface 120 may include an inner member dental prosthesis securing member 122, illustrated herein as a protrusion. The inner member dental prosthesis securing member protrusion 122 is sized, shaped, and arranged in a position to engage with and secure to a dental prosthesis engagement member outer surface housing assembly securing member 124, illustrated herein as a small depression or a concave circumferential donut shaped recess 126, see FIG. 3 or 4. When secured together, the inner member dental prosthesis securing member protrusion 122 snaps in and rests within the small depression or concave circumferential donut shaped recess 126.

The dental prosthesis engagement member outer member 112, which may be made of titanium, is designed to fit onto and secure to the outer surface 128 of the nylon retention sleeve 110, and comprises a top portion or wall 130 and two side portions 132 and 134. The side portions 132 and 134 may form a continuous side wall. The bottom portion is open. The inner surface 136 of the outer member 112 is configured to align with and rest along the nylon retention sleeve 110 when the two components are secured together. The side portions or walls 132 and 134 or the inner surface 136 may be parallel or have a taper which is conjugate to a parallel surface or tapering of the nylon retention sleeve 110 so that, when the two components are connected together, the outer member inner surface 136 and the nylon retention sleeve surface 128 properly align. An inner member to outer member securing portion, illustrated herein as a protuberance 138 positioned on the inner surface 136 of the outer member 112 is configured to engage with and secure to the outer member to inner member securing portion, illustrated herein as a concave recess 140. The concave recess 140 is positioned on the outer surface 128 of the inner member 110 and aligned in an opposite manner from the inner member dental prosthesis securing member protrusion 122. The concave recess 140 is sized and shaped to receive and hold therein the inner member to outer member securing portion protuberance 138, see FIG. 3. To aid in maintaining a secured housing assembly 18, the outer member 112 may include an inner shoulder 142 sized and shaped to click engage with a corresponding conjugate inner member outer shoulder 144.

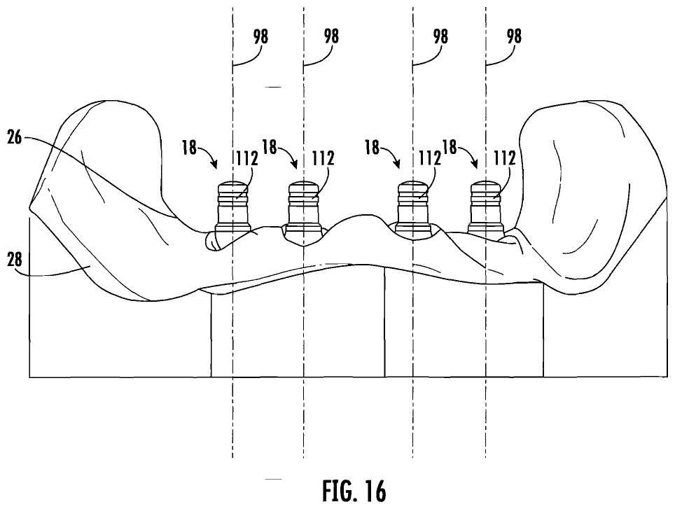

To aid in securing the dental prosthesis, such as the denture 109, one or more portions of the housing assembly 18 may be inserted into the denture 109. Referring back to FIG. 15, the denture 109 is shown with openings 146 on the upper surface 148. Placed within the denture surface opening 146 may be the housing assembly 18. In this case, the user may simply secure the denture 109 to the dental implant body 12 by securing the housing assembly 18 denture surface opening 146 to the dental implant bodies 12 implanted within the jaw so they secure to corresponding dental prosthesis engagement members 16 secured thereto. Alternativity, the denture surface opening 146 may be aligned with dental implant bodies 12 having the housing assembly 18 already secured to the dental prosthesis engagement members 16. FIG. 16 illustrates multiple implant bodies 12 with the housing assembly 18 secured thereto inserted into the bone ridge 26 of the jaw mandible or the maxilla 28.

The dental implant system 10 may be provided as a kit. Accordingly, the kit may contain (1) one or more of the implant body 12, (2) one or, more of the primary or first abutment 14, (3) one or more of the dental prosthesis engagement member 16, (4) one or more of the housing assembly 18, including one or more of the inner members 110 and outer members 112, or any combination thereof.

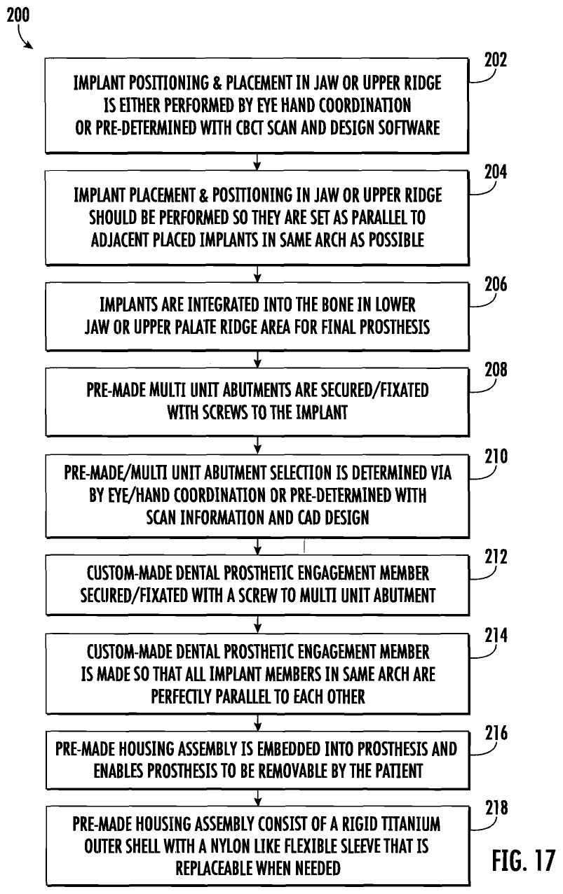

Referring to FIG. 17, a schematic diagram of a method of use 200 associated with the dental implant system 10 is provided. The dental implant body 12 positing and placement in the jaw or upper ridge may be accomplished by visualization or by scanning, see step 202, and preferably set to be parallel to adjacent implants, see step 204. The dental implant body 12 can be integrated into the bone of the jaw or upper ridge for the final prosthesis see step 206. To an existing dental implant body 12 (or one inserted by a user such as a dental practitioner) integrated into the bone in the jaw or upper palate ridge area, see step 208, a user secures the first abutment 14 thereto, see step 210. Selection of the first abutment 14 may be made by visualization or computer aided, see step 210. The user may then secure the dental prosthesis engagement member 16 to the first abutment 14, step 212. The dental prosthesis engagement member 16 is preferably made so to achieve parallel implants (using components with varying degrees associated with the dental prosthesis engagement members 16 or the first abutments 14) in the same arch, see step 214. The user then secures one or more portions of the housing assembly 18 to the dental prosthesis engagement member 16, step 216. In this step, the user may use an angulated driver 150 or common dental screw driver, see FIG. 1C. One or more components of the dental prosthesis engagement member 16 (i.e. the outer shell or outer member 112, or flexible sleeve or the inner member 110), when required, may be replaced, see step 218.

All patents and publications mentioned in this specification are indicative of the levels of those skilled in the art to which the invention pertains.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A dental implant system comprising:
a first abutment configured to be secured to a dental implant;
a dental prosthesis engagement member, said first abutment comprises a first end configured to receive and secure to at least a portion of said dental prosthesis engagement member and a first end body having a center plane, a second end configured to receive and secure to at least a portion of said dental implant body first end and having an independent center plane, and a main body therebetween;
and a housing assembly comprising an inner member and an outer member, said inner member configured to secure to said dental prosthesis engagement member.

2. The dental implant system according to claim 1, further inducing a dental implant body configured to be insertable and securable into an anatomical structure of an individual's mouth, said dental implant body comprising a first end configured to secure to said first abutment, an opposing second end implantable to said anatomical structure of an individual's mouth, and an elongated body separating said first end and said second end.

3. The dental implant system according to claim 2, wherein said abutment second end center plane is oriented to intersect said first end body center plane or at an angle.

4. The dental implant system according to claim 3, wherein said angle is between zero degrees and thirty degrees.

5. The dental implant system according to claim 4, wherein said angle is zero-degrees, six-degrees, ten-degrees, fourteen-degrees, seventeen-degrees, twenty-two-degrees, twenty-six-degrees, or thirty-degrees.

6. The dental implant system according to claim 2, wherein said dental prosthesis engagement member comprises an upper end having a top surface, a collar having a bottom edge configured to engage at least a portion of said abutment, and a main body therebetween.

7. The dental implant system according to claim 6, wherein said collar comprises an angled bottom edge.

8. The dental implant system according to claim 7, wherein said collar angled bottom edge is between greater than zero degrees and fifteen degrees.

9. The dental implant system according to claim 7, wherein said dental prosthesis engagement member and said abutment are secured together using complimentary locking members.

10. The dental implant system according to claim 1, wherein said housing assembly inner member and said outer member are secured together via frictional fit.

11. The dental implant system according to claim 1, wherein said housing assembly inner member is a retention sleeve made of a flexible material.

12. The dental implant system according to claim 11, wherein said retention sleeve made of a flexible material is nylon.

13. The dental implant system according to claim 1, wherein said housing assembly inner member secures to said dental prosthesis engagement member via frictional fit or without a screw.

14. The dental implant system according to claim 1, wherein said dental prosthesis engagement member comprises a small depression or a concave circumferential donut shaped recess sized and shaped to engage with an inner member dental prosthesis securing member.

15. The dental implant system according to claim 1, wherein said implant system comprises at least two dental implants, at least one of said two dental implants having at least one of said a first abutment or said dental prosthesis engagement member secured thereto and oriented to be in a parallel arrangement relative to said first abutment or said dental prosthesis engagement member of an adjacent said at least two dental implants.

16. The implant system according to claim 15, wherein all of said at least two dental implants are arranged so each of said first abutments or said dental prosthesis engagement members are oriented relative to each other in a parallel manner.

17. A dental implant kit comprising:
one or more abutments comprising a first end configured to receive and secure to at least a portion of a dental prosthesis engagement member, a first end body having a center plane, a second end configured to receive and secure to at least a portion of said dental implant body first end and having an independent center plane, and a main body therebetween, each said abutment configured to be secured to a dental implant;
one or more dental prosthesis engagement members; and
one or more housing assemblies comprising an inner member and an outer member, said inner member configured to secure to said one or more dental prosthesis engagement members.

18. The dental implant kit according to claim 17, further including one or more dental implants bodies.

19. The dental implant kit according to claim 17, wherein said one or more abutments include angles of intersection of zero-degrees, six-degrees, ten-degrees, fourteen-degrees, seventeen-degrees, twenty-two-degrees twenty-six-degrees, or thirty-degrees, or combinations thereof.

20. A method of implanting a dental implant system, comprising:
securing to a dental implant body, an implant body first abutment;
securing a dental prosthesis engagement member to said dental implant body, said first abutment comprising a first end configured to receive and secure to at least a portion of said dental prosthesis engagement member and a first end body having a center plane, a second end configured to receive and secure to at least a portion of said dental implant body first end and having an independent center plane, and a main body therebetween;
securing one or more portions of a housing assembly to said dental prosthesis engagement member, said housing assembly comprising an inner member and an outer member, said inner member configured to secure to said dental prosthesis engagement member.
